(19) United States
(12) Patent Application Publication
(10) Pub. No.: US 2013/0185160 A1
(43) Pub. Date: Jul. 18, 2013

(54) SYSTEM, METHOD AND COMPUTER PROGRAM PRODUCT FOR ADVERTISING

(71) Applicant: MUDD ADVERTISING, Cedar Falls, IA (US)

(72) Inventors: Robert Mudd, Chicago, IL (US); Gary Kroeger, Waterloo, IA (US)

(73) Assignee: MUDD ADVERTISING, Cedar Falls, IA (US)

(21) Appl. No.: 13/752,581

(22) Filed: Jan. 29, 2013

Related U.S. Application Data
(63) Continuation-in-part of application No. 12/826,392, filed on Jun. 29, 2010, now abandoned.
(60) Provisional application No. 61/221,643, filed on Jun. 30, 2009.

(51) Int. Cl. G06Q 30/02

(52) U.S. Cl. CPC G06Q 30/0269
USPC 705/14.66

(57) ABSTRACT

A system, method and computer program product to provide content and information and track levels of interaction with provided content and information. Exemplary embodiments may include a server that provides variable content to one or more people in the form of a website. The website may be dynamic to allow for the targeting of people with certain interests or targeted towards individuals. The server may provide content to attract viewers to the website, retain viewers on the website and direct viewers to any other website, product offering or service offering through any of a variety of manners.

### PRIORITY CLAIM

This application is a Continuation-In-Part of U.S. patent application Ser. No. 12/826,392, filed Jun. 29, 2010, and claims priority to U.S. Provisional Patent Application No. 61/221,643, filed Jun. 30, 2009, the entire contents of which are hereby incorporated by reference.

### BACKGROUND

The use of advertising in attempting to attract viewers to website is a common methodology. Various methods of advertising include spam email, pay-per-click advertisements, banner ads and the like. These methods, however, are often seen as intrusive, irritating and off-putting to internet users. Moreover, the ads frequently are untargeted and appear to all users of a website or web portal. Additionally, the websites to which the subjects of these advertisement methods are directed often do not contain information relevant or of interest to the viewers of the website.

### BRIEF DESCRIPTION

A system, method and computer program product to provide content and information. Exemplary embodiments may include a server that provides variable content to one or more people in the form of a website. The website may be dynamic to allow for the targeting of people with certain interests or targeted towards individuals. The server may provide content to attract viewers to the website, retain viewers on the website and direct viewers to any other website, product offering or service offering through any of a variety of manners.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a schematic diagram of an exemplary computing environment.

FIG. 2 is an exemplary diagram of a method, system and apparatus for providing website content and retaining website viewers.

FIG. 3 is another exemplary diagram of a method, system and apparatus for providing website content and retaining website viewers.

FIG. 4 is an exemplary diagram showing a system for tracking engagement with delivered advertisements implementing an intermediary server.

FIG. 5 is an exemplary diagram showing another system for tracking engagement with delivered advertisements implementing an intermediary server.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

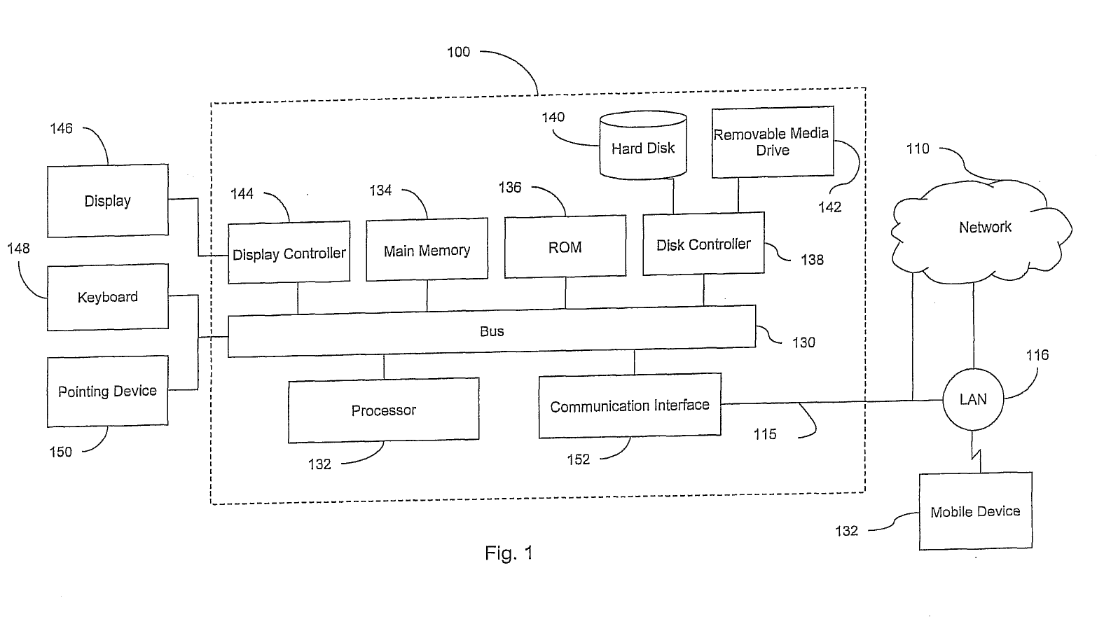

FIG. 1 is a schematic illustration of a computing environment or system 100. System 100 may be any known type of computing environment or system, for example a computer, server and the like. In the exemplary embodiment, system 100 may be coupled in communication to any other computing environment or system, for example, but not limited to a web portal, using a network 110. In the exemplary embodiment, network 110 may be the Internet. In an alternative embodiment, network 110 may be a local area network (LAN), a wireless LAN, a wide area network (WAN) and/or any other type of connection that enables system 100 to function as described herein. System 100, in some exemplary embodiments, may also include one or more servers and one or more databases communicatively coupled to network 110.

In the exemplary embodiment, the term “system” is not limited to just those integrated circuits referred to in the art as a computer, but broadly refers to a processor, a microcontroller, a microcomputer, a programmable logic controller, an application specific integrated circuit and other programmable circuits. These aforementioned terms may be used interchangeably herein. In the exemplary embodiment, system 100 may include a bus 130 or other communication mechanism for communicating information, and a processor 132 coupled with bus 130 for processing the information. In one embodiment, a plurality of processors 132 may be arranged in a multi-processor arrangement to facilitate faster processing as compared to a single processor arrangement. In the exemplary embodiment, system 100 may also include a main memory 134, such as a random access memory (RAM) or other dynamic storage device (e.g., dynamic RAM (DRAM), static RAM (SRAM) and synchronous DRAM (SDRAM)) coupled to bus 130 for storing information and instructions to be executed by processor 132. In addition, main memory 134 may be used for storing temporary variables or other intermediate information during the execution of instructions by processor 132. System 100 may further include a read only memory (ROM) 136 or other static storage device (e.g., programmable ROM (PROM), erasable PROM (EPROM) and electrically erasable PROM (EEPROM)) coupled to bus 130 for storing static information and instructions for processor 132.

System 100 may also include a disk controller 138 coupled to bus 130 to control one or more storage devices for storing information and instructions. In the exemplary embodiment, storage devices may include, but not limited to, a magnetic hard disk 140 and a removable media drive 142 (e.g., floppy disk drive, read-only compact disc drive, read/write compact disc drive, compact disc jukebox, tape drive and removable magneto-optical drive). The storage devices may be coupled to system 100 using any appropriate device interface known to one having ordinary skill in the art (e.g., small computer system interface (SCSI), integrated device electronics (IDE), enhanced-IDE (E-IDE), direct memory access (DMA), or ultra-DMA). System 100 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

In the exemplary embodiment, main memory 134, hard disk 140 and removable media drive 142 are examples of computer-readable mediums that facilitate holding instructions programmed according to the teachings of the invention, data structures, tables, records and/or other data described herein. The term “computer-readable medium” or “computer-readable media” as used herein refers to any medium that facilitates storing and/or providing instructions to processor 132 for the execution thereof. The computer-readable media may include, but not limited to, non-volatile media, volatile media and transmission media. Non-volatile media may include, but not limited to, hard disks, floppy disks, tape, magneto-optical disks, PROMs (EPROM, EEPROM, flash EPROM) or any other magnetic medium. Moreover, non-volatile media may also include compact discs (e.g., CD-ROM) or any other optical medium. Further, non-volatile media may include punch cards, paper tape or other physical medium with patterns of holes. Volatile media may include dynamic memory, such as main memory 134. Transmission media may include coaxial cables, copper wire and fiber optics, including the wires that make up bus 130. Transmission media may also include carrier waves such as acoustic or light waves that may be generated using radio waves and infrared data communications.

In the exemplary embodiment, the computer-readable media may include software that facilitates controlling system 100. Such software may include, but is not limited to, device drivers, operating systems, development tools and applications software. Such computer-readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

In the exemplary embodiment, system 100 may further include a display controller 144 coupled to bus 130 to control a display 146, such as a cathode ray tube (CRT), liquid crystal display (LCD) or any other type of display to facilitate displaying information to a computer user. System 100 may include a plurality of input devices, such as a keyboard 148 and a pointing device 150, to facilitate interacting with the computer user and providing information to processor 132. Alternatively, a touch screen may be used in conjunction with display 146. In one embodiment, pointing device 150 may be a mouse, a trackball or a pointing stick for communicating direction information and command selections to processor 132 and for controlling cursor movement on display 146. In addition, a printer (not shown) may be coupled to system 100 to facilitate printing data stored and/or generated by system 100.

System 100 may also include a communication interface 152 coupled to bus 130, wherein communication interface 152 may be coupled in communication to LAN 116 or network 110 using network connection 115. In one embodiment, communication interface 152 may be a network interface card that is coupled in communication to any packet switched LAN. In another embodiment, communication interface 152 may be an asymmetrical digital subscriber line (ADSL) card, an integrated services digital network (ISDN) card or a modem to facilitate providing a data communication connection to network connection 115. In yet another embodiment, wireless connections may be used to couple communication interface 152 to LAN 116 and/or network 110. In the exemplary embodiment, communication interface 152 sends and receives electrical, electromagnetic or optical signals that carry digital data to and from system 100, which are exemplary forms of carrier waves that facilitate transporting information. Network connection 115 facilitates providing data communication between any web portal and any data devices using networks 116 and 130. System 100 may also transmit and receive data, including program code, through networks 116 and 110 using network connection 115 and communication interface 152. Moreover, network connection 115 may couple system 100 in communication to a mobile device 132 such as a personal digital assistant (PDA), a laptop computer, a cellular telephone, a smart phone, an ultra-compact mobile device or any other mobile device that enables system 100 to function as described herein.

During operation, system 100 may perform a portion or all of the processing steps of the invention in response to processor 132 executing one or more sequences of one or more instructions contained within main memory 134 and/or other forms of computer-readable media. In one embodiment, processor 132 may execute the instructions contained within the computer-readable media. In another embodiment, hard-wired circuitry may be used in place of or in combination with the instructions. Thus, the exemplary embodiments described herein are not limited to any specific combination of hardware circuitry and software. For example, the instructions may initially be carried on a magnetic disk of a remote computer. The remote computer can load the instructions for implementing all or a portion of the present invention remotely into a dynamic memory and send the instructions over a telephone line using a modem. A modern local to system 100 may receive the data on the telephone line and use an infrared transmitter to convert the data to an infrared signal. An infrared detector coupled to bus 130 can receive the data carried in the infrared signal and place the data on bus 130. Bus 130 carries the data to main memory 134, from which processor 132 retrieves and executes the instructions. The instructions received by main memory 134 may optionally be stored on hard disk 140 or removable media drive 142 either before or after execution by processor 132.

Other aspects of the invention may include data transmission and Internet-related activities. See Gralla, Preston, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

In one exemplary embodiment, a method, system and apparatus for disseminating and collecting data and a method and system for directing and retaining internet-based traffic may be described. The method, system and apparatus can include any of a variety of components, for example one or more websites, one or more servers and any type of media or content that may be displayed on a website, such as video. The method, system and apparatus may be utilized for any of a variety of purposes, for example achieving a high retention rate on a website or increasing the length of average website views.

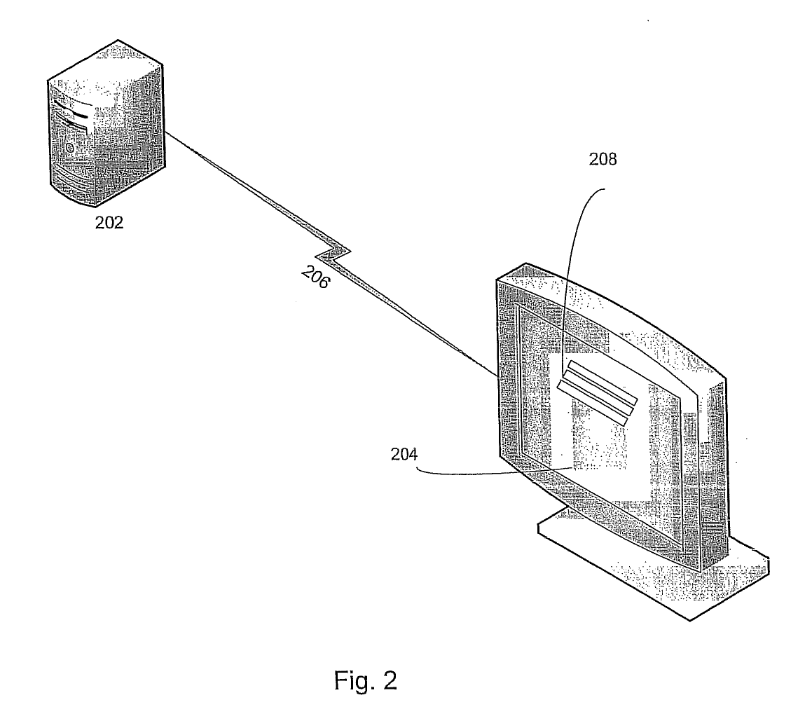

In a further exemplary embodiment, and as shown in exemplary FIG. 2, a server 202 may host a website 204. The server 202 may provide the website 204 with any desired content, for example content that may be used to demonstrate or advertise a product a service or otherwise attract or retain viewers to the website. The website 204 may be formed in any known manner, for example using HTML, XML, Java, Perl, ASP, Cold Fusion or any other language, software or combination thereof. Additionally, the website 204 may be targeted towards any audience, for example an audience that is interested in a product or service. The website 204 may be targeted to a desired audience through the use of content that includes any subject and any media, for example videos, images and text.

As discussed previously, the website 204 may be housed on a server 202. Data can be retrieved from the server 202 via any type of network connection 206 and displayed to a viewer of the website 204 when an appropriate website address is entered into an internet browser. The content, as stated above, may be targeted to a specific type of website viewer or a viewer with a particular interest. Additionally, the website 204 may provide a viewer with one or more areas within which to enter data, for example one or more data entry fields 208. The data entry fields 208 may be provided for any purpose, for example to have the viewer of the website 204 enter his or her contact information into the fields 208 or to enter the contact information of another viewer or potential viewer into the fields 208.

In a still further exemplary embodiment, after a visitor views the website 204 and any or all associated content, the visitor then may be prompted with one or more data entry fields 208. The data entry fields 208 can be prefaced or headed with any desired text. For example, the data entry fields 208 could be headed with text indicating that the viewer of the website 204 and any associated content may desire to enter in data regarding themselves in order to receive additional content, additional information or some form of incentive. In other exemplary embodiments, the data entry fields 208 could be headed by a request that the viewer enter the data of another individual or individuals who the viewer believes may be interested in the content or features of the website 204.

The data that may be entered in the data entry fields 208 may be any type of data. In some exemplary embodiments, the data may include the name, phone number, physical address, email address and/or any other contact information associated with the viewer of the website. Additionally, depending on the nature or content of the website, any of a variety of additional information may be requested of the viewer or of the individual or individuals that the viewer believes may be interested in the content or features of the website 204. For example, the viewer may be presented with an option to choose a feature, product or service that he or she feels is most relevant or beneficial to another party. However, any data entry fields 208 may be populated with any of a variety of choices or options, and any desired question may be presented for the viewer of a website to answer.

After data is entered into the one or more data entry fields 208 and following the submission of the data through any known or desired methodology, the data may be transmitted to the server 202 or any other server capable of disseminating the distributing data. The server 202 may then interpret the data. In some exemplary embodiments, for example where an email address is entered, the server 202 may include logic configured to send an email to the relevant email address. The content of the email may further be populated by the server, in some exemplary embodiments. For example, if the data in the one or more data entry fields 208 includes the name of an individual, the name may be included in a salutation or any other desired portion of an email. In still further exemplary embodiments, any information in the one or more data entry fields 208 may be used in an email sent by the server 202 or used by the server 202 to prompt the inclusion of other data or information in an email to the desired email address. Additionally, the body of the email that the server 202 generates may include a link to a website. As explained in more detail below, the link may be to any website, for example a website associated with the server 202, such as website 204, and further a website associated with the server 202 that is customized or otherwise tailored to the recipient of the email. In some examples, the customized or tailored website may be similar in appearance and content to website 204, but may contain additional data.

In a further exemplary embodiment, after the server 202 sends the email to the desired email address, the email may be received and viewed by the recipient of the email in any known or desired fashion. The recipient of the email may read the content of the email and may be presented with a link to a website, as mentioned previously. The recipient of the website may then click on the link to the website, or otherwise navigate to the desired website.

Upon loading the website found in the link that was sent to the email recipient, the email recipient (referred to hereinafter as the “targeted viewer” of the website) may be presented with a website substantially similar to the website previously viewed by the viewer described above. However, in some examples, the content of the website may be customized or tailored to the targeted viewer of the website. In some exemplary embodiments, the server 202 may generate a website can feature any of a variety of the information previously submitted to the server 202 through the use of the one or more data entry fields 208.

For example, the targeted viewer of the website may be presented with a website that contains any of a variety of content that specifically references or relates to the targeted viewer. The content may be that which was provided to the server through inputs provided by another viewer of the website. Here, the website and its content may include reference to the targeted viewer's name, age, occupation or any other relevant or desired references or information. Additionally, the content may also be more generally targeted at a certain demographic. In these examples, while there may also be content that references an individual targeted viewer, there may also be content that the demographic is more broadly interested in. For example, the content may include sports or athletic news for a targeted viewer who follows a sport or sports team. Similarly, the content may include deals or incentives on a certain product for a targeted viewer who may be shopping for a specific product or who may be interested in a certain range of products.

In yet another exemplary embodiment, after a targeted viewer opens a website that is customized or prepared specifically for the targeted viewer, the website may play a video that contains information pertaining to the targeted viewer. For example, a video may open with a salutation that includes that targeted viewer's name. The salutation may be in the form of text, audio, animation or any other form of media or combination of different forms of media. The video may then contain any number of references to any available known information regarding the target viewer, such as his or her name and his or her preference regarding any of a variety of product, services or other item that the website may be promoting. Additionally, as stated previously, any of the references to any available known information regarding the target viewer may be in any type of media.

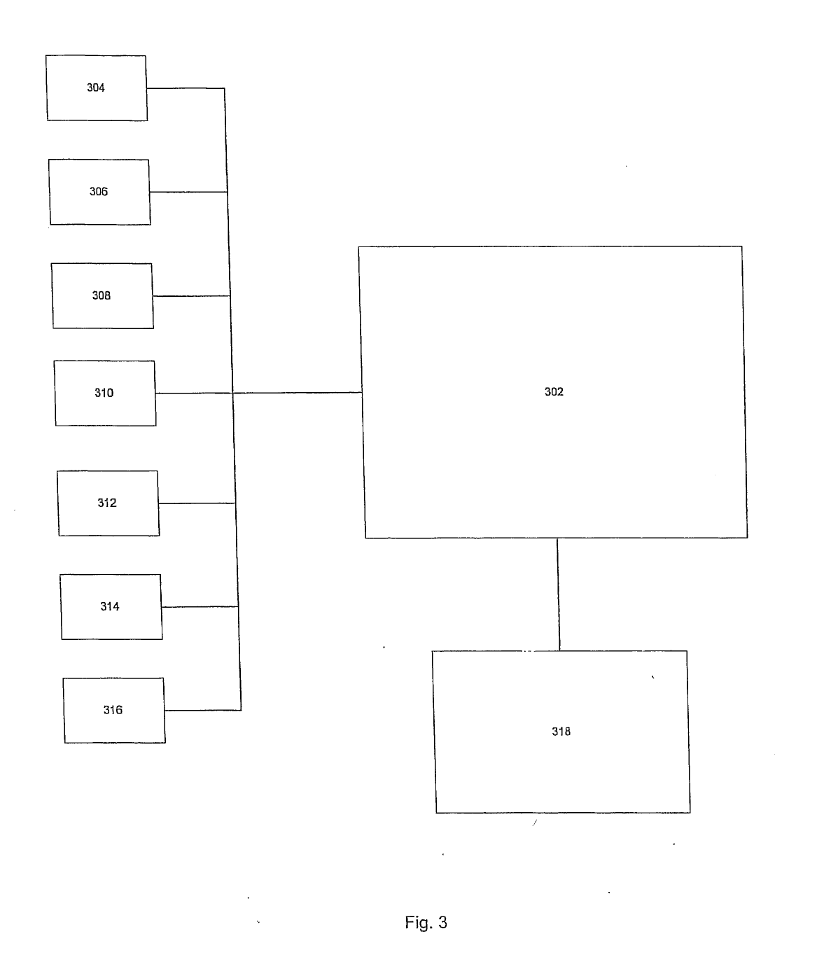

In another exemplary embodiment, and as shown in FIG. 3, any of a variety of techniques may be used to direct a viewer to a website. In some exemplary embodiments, a website may have a banner ad 304. If the viewer clicks on banner ad 304, they may be taken to a website 302 having any of a variety of media displayed thereon. The website 304 to which banner ad 304 is connected may further contain any of the indicia listed above, for example one or more data entry fields that allow a viewer of the website to enter personal data regarding him or herself or one or more data entry fields that allow a user of the website to enter in the contact information, e.g. email address and name or any other information, of another person who may be interested in the content of the website.

In other exemplary embodiments, traffic may be directed to a website 302 in any of a variety of manners, such as a television or radio ad 306 or print ad 308. In these exemplary embodiments, a television or radio ad 306 may provide a radio listener with audio cues to visit a website, such as an audio reference to a website URL, whereas a television ad 308 may provide a television viewer with both audio and visual cues to visit a website, such as an audio and visual reference to a website URL. The website the listener and viewer, respectively, may be directed to may be on described above, that contains any of a variety of content that the individual viewing the website may be interested in. Additionally, the website may have any of the features described above, such as the ability to allow for the entry of data regarding other parties, so as to customize or target the website to a specific viewer.

In further exemplary embodiments, a viewer of a website may receive information regarding the website via direct mail 310. In this exemplary embodiment, the mail may contain a reference to a website, such as a URL described with respect to the radio and television ads 308. However, if information about the mail recipient is known, the direct mail 310 may contain a personalized or customized website and corresponding personalized URL (PURL). In these exemplary embodiments, the website referred to by the PURL may be targeted or customized so that any information on the website may be directly related to the direct mail recipient, similar to exemplary embodiments described above. Similarly, email 312 may be sent to an email recipient. Similar to the exemplary embodiments regarding direct mail 310, email 312 may contain either a website URL or PURL that the email recipient mail click on or navigate to through any other known manner, depending on the amount of information known about the email recipient.

In yet another exemplary embodiment, an internet user may be presented with an online advertisement 314 that contains a link to a website. Similar to the exemplary embodiments described above, the online advertisement 314 may be targeted to a non-specific viewer and contain a more general URL or, in situations where some information is known about the viewer, the online advertisement 314 may be targeted to the specific viewer and contain a PURL.

In still other exemplary embodiments, an individual may be presented with any of a variety of different types of search engine marketing (SEM) 316. SEM 316 may be any form of advertisement associated with searching or search engines, such as pay-per-click advertisements. Similar to the above exemplary embodiments, SEM 316 may contain a link that is either more general, such as a URL, or more specific, such as a PURL, depending on the amount of information that is known about the individual using the search engine.

In further exemplary embodiments, and still referring to FIG. 3, the website 302 may have any of a variety of components and content. For example, a website may contain a video that refers to a specific product, service, offer, or any other desired promotion. As discussed previously, depending upon the viewer of the website and the amount of information known about the viewer, the website content may be tailored, customized or configured to refer specifically to a targeted viewer or may contain more general information, if desired information about the viewer is not known.

Additionally, any content on website 302 may be hosted on a server that is separate that is independent. Thus, the content on website 302 may be such that it can be rapidly and dynamically updated or customized. In further exemplary embodiments, if a client who offers any type of product or service to be displayed or advertised on website 302 and the client maintains a separate website, for example 318, where a viewer of website 302 may learn more about a desired product or service, website 302 may contain any of a variety of links or references to website 318. Therefore, website 302 can be designed so as to appeal to both a specific type of viewer as well as individually targeted viewers, as described previously, while the client website 318 is not affected. However, the content on website 302 may be such that it captivates any type of viewer and directs viewers to website 318. For example, a video that specifically targets an individual or a variable video may be shown on website 302. The video may contain, for example, specific references to the individual's name and may provide any desired information about a product or service that the individual may be interested in. The video and any other content on website 302 may also contain information about how the individual can obtain any product or service described on website 302 or how the individual can obtain more information about the product or service described on website 302. In some exemplary embodiments, website 302 may direct an individual to website 318 to obtain or learn more about a product or service through the use of one or more links to website 318. In still other exemplary embodiments, website 302 may offer one or more incentives for a user to navigate to website 318, such as an additional offer including, but not limited to, a discount, rebate, limited time promotion, gift or any additional desired content.

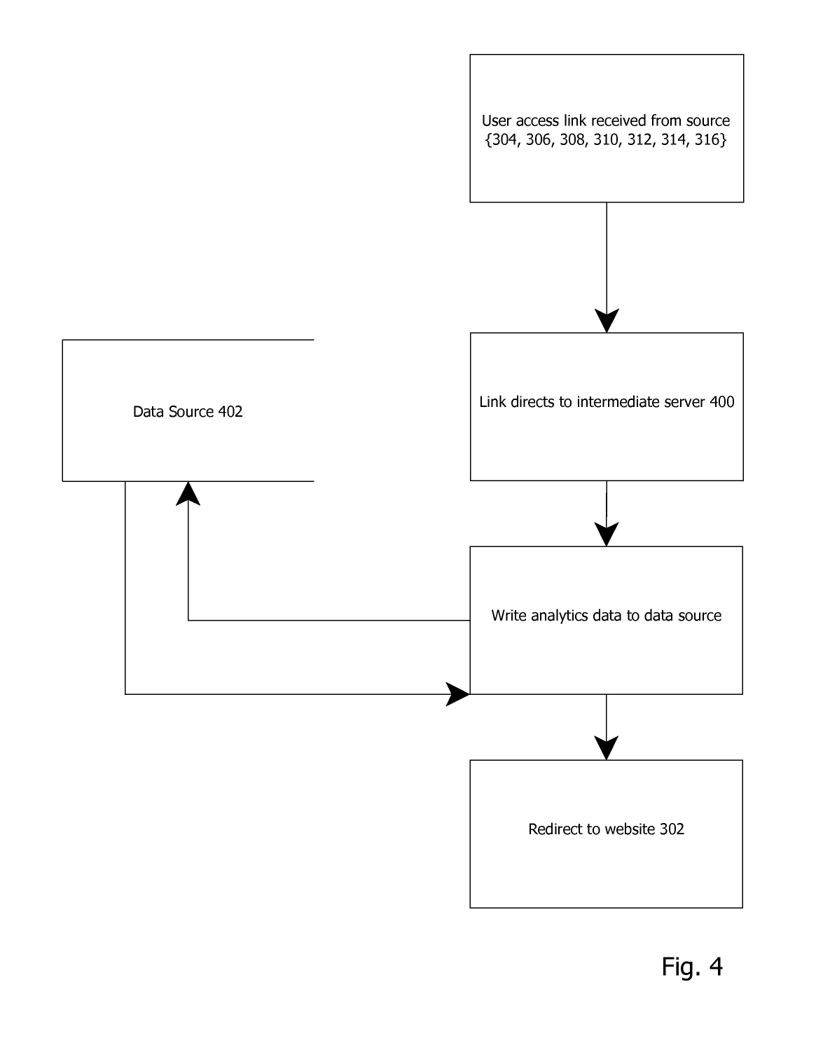

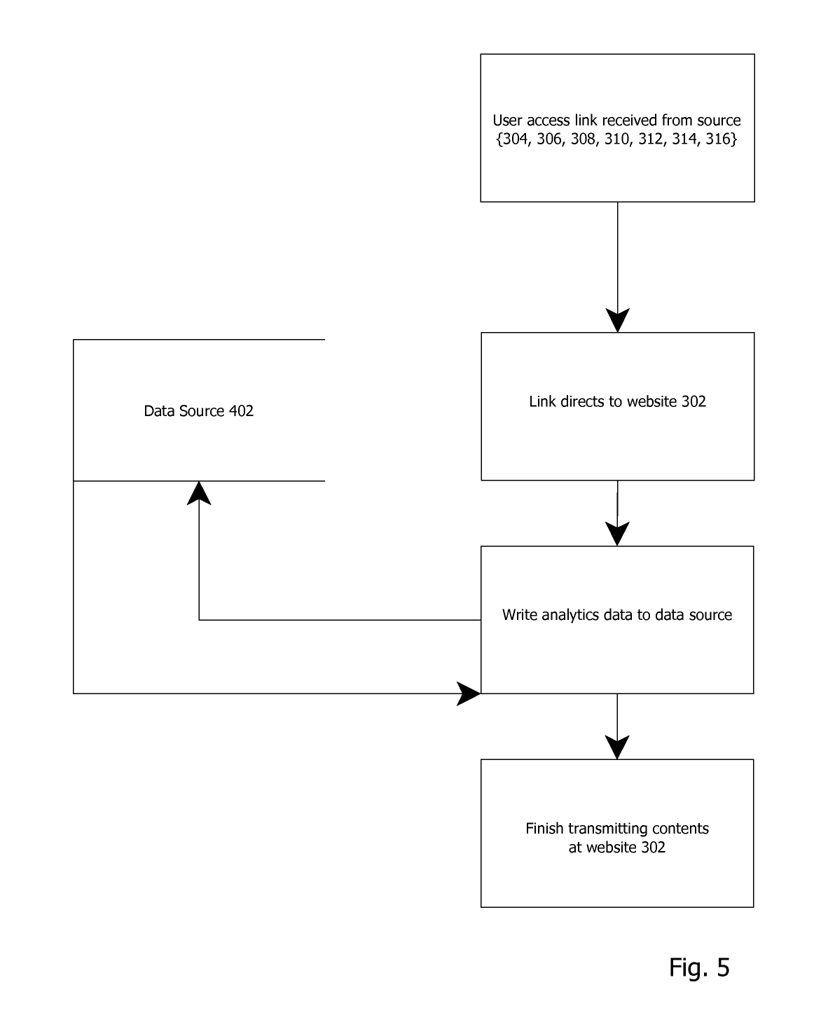

Now referring to FIGS. 4 and 5, a system for tracking responses to advertisements provided by the above described system for providing customized advertisements may also be disclosed. When an advertisement is delivered over a network connection to an end user, a notification may be sent to a data source that a particular advertisement has been transmitted with a link to a particular uniform resource locator. When a user visits the web property associated with a delivered uniform resource locator, the web property may communicate with a data source to indicate interaction with a particular uniform resource locator and a particular advertisement. In some embodiments, the data source may be a relational database; in other embodiments, the data source may be a flat file or any other appropriate computer-readable data repository as known in the art. The data source may be stored on the server hosting the advertisements or on a remote machine. Notifications may be sent and recorded through a database query, a file read/write process, or other methods of writing data to a data source stored on nontransitory computer-readable media known in the art.

In an exemplary embodiment, an ad delivery system can deliver an advertisement to a user and record that said advertisement has been delivered to the user. Where advertisements are delivered to users as content on a web page, this system can record delivery of a particular advertisement each time an advertisement is displayed; in embodiments where advertisements are delivered on broadcast television, telemarketing, or by print, the number of delivered advertisements may be recorded at one time before or after delivery of said advertisement. In some embodiments, the data source may associate particular uniform resource locators with particular advertisements; in other embodiments, the data source may be configured to record interaction with a delivered advertisement regardless of the uniform resource locator delivered with the advertisement.

Referring specifically to FIG. 4, an embodiment of an system for tracking engagement with delivered advertisements implementing an intermediary server may be disclosed. A uniform resource locator provided with an advertisement {304, 306, 308, 310, 312, 314, 316} may first direct a user to an intermediary server 400. The intermediary server 400 may be connected to a data source 402 configured to associate each provided uniform resource locator with a destination uniform resource locator. When a user follows the link provided in delivered advertisement {304, 306, 308, 310, 312, 314, 316}, the web property at the provided uniform resource locator can first communicate with data source 402 to record interaction with a delivered advertisement. In some embodiments, each uniform resource locator directing to an intermediary server can be unique and associated with a single advertisement; in other embodiments, a delivered uniform resource locator can have a common domain name portion and any number of query string properties (similar to form data transmitted using the HTML GET method) indicating, inter alia, the advertisement associated with the delivered uniform resource locator. After the interaction has been recorded, the intermediary server may direct the user to the destination with which the delivered uniform resource locator is associated. In embodiments where a personalized uniform resource locator resolves to a unique static web property, the data source can be configured to record information about which users have interacted with an advertisement as well as overall interaction with an advertising campaign where users are provided personalized uniform resource locators. In other embodiments using personalized uniform resource locators, personalization properties may be contained in a query string. Interaction with a uniform resource locator may be recorded, and the personalization properties may be passed on to the destination web property located at the destination uniform resource locator.

Now referring to FIG. 5, an alternative embodiment of a system for tracking engagement with delivered advertisements may be disclosed. In an alternative embodiment, a uniform resource locator provided with an advertisement through sources {304, 306, 308, 310, 312, 314, 316} may direct the user to the destination web property at website 302 without first proceeding through an intermediary server. When website 302 is loaded, the website may record data about interaction with an advertisement by accessing data source 402, which may be configured to store information about advertisements and delivered uniform resource locators. The data source may be accessed through an application programming interface (API), direct access to a relational database, direct read/write access to a flat file, or any other method known in the art. After recording interaction data, a server may finish transmitting the contents of the web property at the provided uniform resource locator, including any personalization that may have been delivered with the advertisement. This process may be invisible to the person accessing a web property at the provided uniform resource locator.

A system for tracking engagement with delivered advertisements may also provide analytic analysis about user interaction with delivered advertisements to an advertiser. In some embodiments where data is accessible from a remote connection, for example, database queries, access to data through an API, or other methods of remote access to data known in the art, analytic analysis may be hosted on an appropriate server. In other embodiments where data is stored in a manner that would prevent remote access, for example, in flat files, analytic analysis may be hosted on the same machine as the data source. In still further embodiments, analytic analysis can be performed on data retrieved from a variety of remote and local sources. It may be recognized that such a system may be implemented on an individual computing device or in a distributed system. Servers hosting flat files may be configured to allow an analytics server to have read access to the flat files, and analytics analysis may be hosted on a desired server so long as said server can access the variety of data sources. Analytic analysis can be delivered both graphically and as textual information to show an advertiser which methods of advertising are more effective in obtaining user interaction and which methods are less effective.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of delivering customized advertisements, comprising a processor configured to:
query a first user for user-related data pertaining to a second user;
store the user-related data in a database;
utilize the user-related data to identify relevant advertising content for the second user;
generate a customized advertisement comprising the relevant advertising content and the user-related data; and
deliver the customized advertisement to the second user.

2. The method of claim 1, wherein the processor is further configured to modify a website to include the user-related data.

3. The method of claim 1, wherein the user-related data comprises demographic information.

4. The method of claim 3, wherein the demographic information comprises one or more of name, age, occupation, address, e-mail address, phone number, interests, and personal preferences.

5. The method of claim 1, wherein the relevant advertising content comprises video content.

6. The method of claim 5, wherein the processor is further configured to:
retrieve the video content from a content database;
insert the user-related data into at least one frame of the video content so as to display the user-related data within the video content.

7. A method of delivering customized advertisements, comprising:
directing a first user to a website comprising at least one data entry field;
inducing the first user to enter user-related data pertaining to a second user into the at least one entry field;
storing the user-related data in a database;
utilizing a processor to customize the website based on the user-related data; and
directing the second user to visit the website.

8. The method of claim 7, wherein directing a first user to visit a website further comprises providing the user with a personalized uniform resource locator for the website.

9. The method of claim 7, wherein utilizing a processor to customize the website based on the user-related data further comprises:
retrieving advertising content from a content database;
inserting user-related data into the advertising content so as to include the user-related data within the advertising content; and
providing the advertising content on the website.

10. The method of claim 9, wherein the advertising content is in a video format.

11. The method of claim 9, wherein the advertising content is in an image format.

12. The method of claim 9, wherein the advertising content is in an audio format.

13. The method of claim 9, wherein the advertising content is in a text format.

14. A system for delivering customized advertisements, comprising:
an accessible database that stores user-related data;
an accessible database that stores advertising content;
a processing device that identifies relevant advertising content based on the user-related data and generates a customized advertisement comprising the relevant advertising content and the user-related data;
a website that provides the customized advertisement for the user; and
a notification that directs the user to the website.

15. The system of claim 14, wherein the notification provides the user with a personalized uniform resource locator for the website.

16. The system of claim 14, wherein the notification comprises an e-mail message.

17. The system of claim 14, wherein the notification comprises a direct mailing.

18. The system of claim 14, wherein the notification comprises a broadcast advertisement.

19. The system of claim 14, wherein the notification comprises a print advertisement.

20. The system of claim 14, wherein the customized advertisement comprises a video.
